(19) United States
(12) Patent Application Publication
(10) Pub. No.: US 2022/0309853 A1
(43) Pub. Date: Sep. 29, 2022

(54) QR Code Land Access Automation

(71) Applicant: QR Posts, LLC, Fargo, ND (US)

(72) Inventors: Levi Otis, Argusville, ND (US); Kyle Reierson, Fargo, ND (US)

(21) Appl. No.: 17/702,324

(22) Filed: Mar. 23, 2022

Related U.S. Application Data
(60) Provisional application No. 63/165,579, filed on Mar. 24, 2021.

(51) Int. Cl. G07C 9/20; G06K 7/14; G06K 19/06

(52) U.S. Cl. CPC G07C 9/20; G06K 7/1417; G06K 19/06037

(57) ABSTRACT

A real-time and account-based land access and management system which utilizes one or more QR and/or bar codes, automatic configuration, a web-based application, and a server or servers. Landlords may use the system to allow or restrict hunter's access to land. Hunters may request access using the system from a web-based internet browser or from a mobile communication device while at the subject land.

### CROSS-REFERENCE TO RELATED APPLICATION(S)

This application claims the priority and benefit to U.S. Provisional Patent Application No. 63/165,579 filed Mar. 24, 2021, the contents of which are hereby incorporated by reference in its entirety.

### BACKGROUND

Hunters and sportsmen often desire to hunt on land which they do not own or have access. Typically, a hunter would attempt to contact the landlord by calling a number on a sign, looking at a plat book, or accessing some other data source. Sometimes contact can be made using the methods and sometimes contact is not possible. When contact is made a landlord might charge a fee, place certain restrictions on the access, or deny access.

Landlords may be bothered at times by large volumes of land access requests. Further landlords may not always have a system to track hunter access. In some legal jurisdictions land is considered open for access by hunters unless the landlord posts or places a sign giving notice that access onto the land is not allowed. The landlord in such circumstance may still be open to allowing hunters access, but want to control how the land is accessed and by whom it is accessed.

### SUMMARY

A real-time and account-based land access and management system which utilizes one or more QR and/or bar codes, automatic configuration, a web-based application, and a server or servers. Landlords may use the system to allow or restrict hunter's access to land. Hunters may request access using the system from a web-based internet browser or from a mobile communication device while at the subject land.

QR and/or bar codes can be used to facilitate the communication of land details, request access, deny access, or begin communication between a landlord and a hunter. Hunters may initiate such facilitation by scanning a sign which has a QR code on it.

An exemplary land access and management system includes a piece of land, a sign posted with a QR print upon it, a remote server, a mobile communication device which can access the internet and has QR scanning capabilities, a payment processing system, and a database of information on the remote server. The hunter may scan the QR code, which initiates a message to a landlord who can decide whether or not to allow access to the land and whether or not to charge for such access.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is a simplified block diagram of a system that provides automated entry to a piece of land in accordance with an implementation;

FIG. 2 is a simplified flowchart of the process which a hunter follows to obtain access to land;

FIG. 3 is an exemplary POSTED sign with a QR Code;

FIG. 4 is a device display illustrating how a landlord may add a piece of land to the database in accordance with an implementation.

### DETAILED DESCRIPTION OF THE ILLUSTRATED EMBODIMENTS

### General

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### Figures Detail

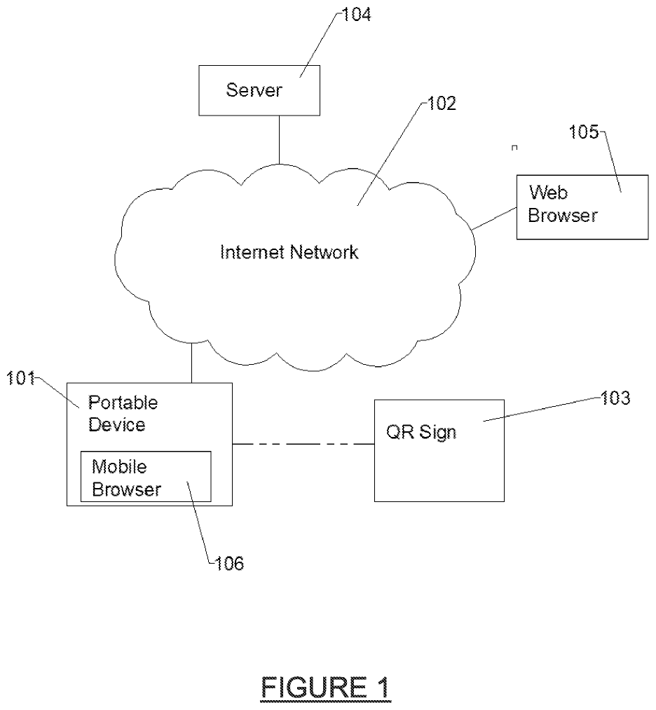

FIG. 1 shows a simplified block diagram of a system. The system is a system for automated permission. A portable device 101 is commonly a mobile phone with a camera. It could also be any other type of smart device such as a tablet computer or some other device capable of reading a QR code 301. The portable device 101 must be capable of accessing an internet network 102 and must also be able to be transported. The portable device 101 must have software installed which allows a user to scan a QR code 301 and be directed to the website address associated with the QR code 301.

A portable device 101 is used to scan a QR code 301 which is displayed on a QR sign 103. The QR code 301 could be alternatively be located on a piece of paper, display screen, or any other type of surface. Generally, a QR sign 103 will be located on or adjacent to a parcel of land. On or adjacent to a parcel of land is considered near a parcel of land. A parcel of land can include any piece of land of any size or topography. A parcel is understood to mean to include all land within any described boundaries. The QR sign 103 is used to communicate that the land is posted and that hunting without permission is not allowed. Many states have laws which govern how a parcel of land is to be posted in order to prohibit a hunter from entering the land for the purpose of hunting or other recreation. Obtaining permission from a landlord has typically required the hunter to determine a way in which to contact the landlord such that permission can be given. Determining a method in which to contact a landlord is often challenging, can be time consuming, and a hassle. The landlord may also be frustrated by numerous hunters contacting them to obtain permission to use the land. A landlord may be a farmer.

In the proposed inventive system and method, a process and system which facilitates communication between a hunter and a landlord is disclosed. The process and system is one in which a user would follow, for example, may include the user using a portable device 101 for scanning the QR code 301 on the QR sign 103. A user may be a hunter. The portable device 101 would use the information from the scan to bring the user to an interface which displays information about the parcel to the user. Such interface commonly would be a mobile browser 106 on the portable device 101. The information provided would be pulled from the internet network 102. Common methods which a portable device 101 uses to access the internet network 102 include wireless internet (WiFi), 3G, 4G, 5G, or any other communication method used to connect a portable device 101 to the internet network 102.

Connected to the internet network 102 is one or more servers. A parcel server 104 containing a list of signed up parcels and information about the parcels of land which have been entered is connected to the internet network 102. A Parcel that has been signed up and is on the server 104 is considered a registered parcel. One or more computers may be connected to the internet network 102 for the purpose of signing up parcels and entering information about parcels of land to the parcel server 104. For example, a computer user can open a web browser 105 and sign up a parcel and enter in the relevant information about the parcel of land. Any variation of computer may be used which can access an internet network 102 and any variation of web browser 105 which is compatible with the internet network 102 may be used. The internet network 102 is commonly considered as the world wide web as well as many other similar terms.

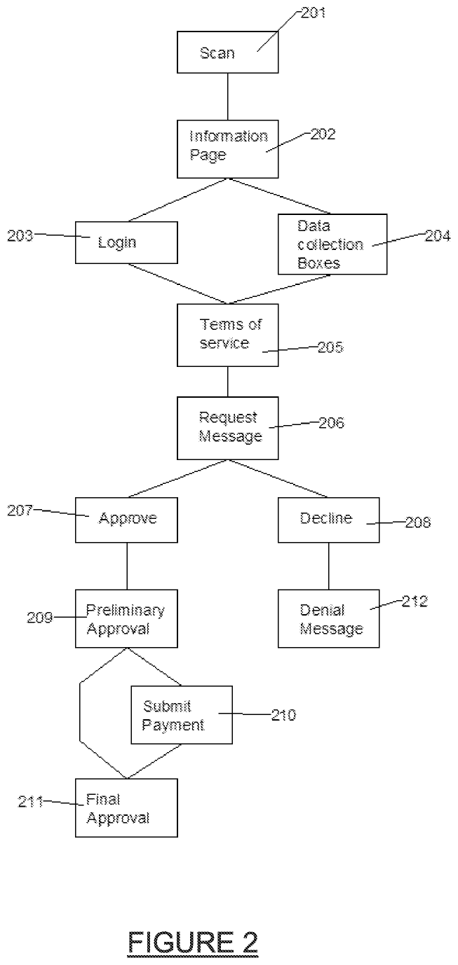

In FIG. 2 an exemplary process is shown wherein a hunter would follow to initiate conversation with a landlord for the purpose of obtaining permission to hunt a parcel of land. A hunter may begin the process primarily by scanning 201 the QR code 301 on a QR sign 103 or any other surface which contains a relevant QR code 301 with a portable device 101. Typically, the scanned QR code 301 causes the mobile browser 106 on the hunter's portable device 101 to open an information page 202 which displays information about the parcel and other terms of use. Examples of information that may be shown include but are not limited to the following: no access allowed, a disclaimer of liability, directions as to where hunting is allowed, and any other information desired to be displayed. A user may provide personal information for send a request message 206. A user may then either login 203 such that personal information is automatically applied to the process or may enter their personal information into the information page 202 data collection boxes 204. The data collection boxes 204 include information such as name, number of hunters, time period desired for hunting, hunting methods, and other relevant information.

Once information is either obtained from a hunter logging in or a hunter entering information into the data collection boxes 204, the mobile browser 106 will require the hunter to agree to the terms of service 205. The terms of service may include a site terms of service agreement, a liability waiver, and other agreements. In the event a hunter does not want to agree, the hunter may exit the browser at any time and end the process. Upon agreeing to the terms of service 205, a request message 206 may automatically be sent to the landlord containing the information collected in the data collection boxes 204. This request message 206 can be sent to an address or phone number as set by the landlord. For example, the request message 206 could be sent to an email address or texted to a phone number. The landlord may elect to adopt an automatic response protocol wherein a hunter is automatically approved to enter the land upon agreeing to the terms of service and paying a fee if applicable. Such selection may further allow the landlord to opt out of the receiving a request message 206.

The request message 206 when sent will notify the landlord that a hunter has agreed to the terms of service 205 and asking to enter the parcel for a particular time period. The landlord may approve 207 the request. If approved the user will be given preliminary approval 209 and may be instructed on the mobile browser 106 to submit payment 210 prior to receiving final approval 211. The mobile browser 106 will allow the hunter to input payment details and submit payment 210. As an option, landlords may allow hunters to access a parcel without payment. In this scenario the submit payment 210 step will be automatically passed. Upon successfully completing the submit payment 210 step, a final approval 211 communication will be delivered to the hunter authorizing the hunter to enter the parcel during the particular time period.

In order to execute the submit payment 210 step, a method for accepting and processing payments must be connected to the system.

Alternatively, the landlord may elect to decline 208 the request to enter the parcel as stated in the request message 206. When a landlord chooses to decline 208 the request the hunter will be given a denial message 212. The denial message 212 will be a message displayed on the mobile browser 106 informing the hunter that access has not been granted. A denial message 212 is considered to reject the request message 206 or a rejection of the request message 206. A rejection means the user is not allowed to enter the registered parcel.

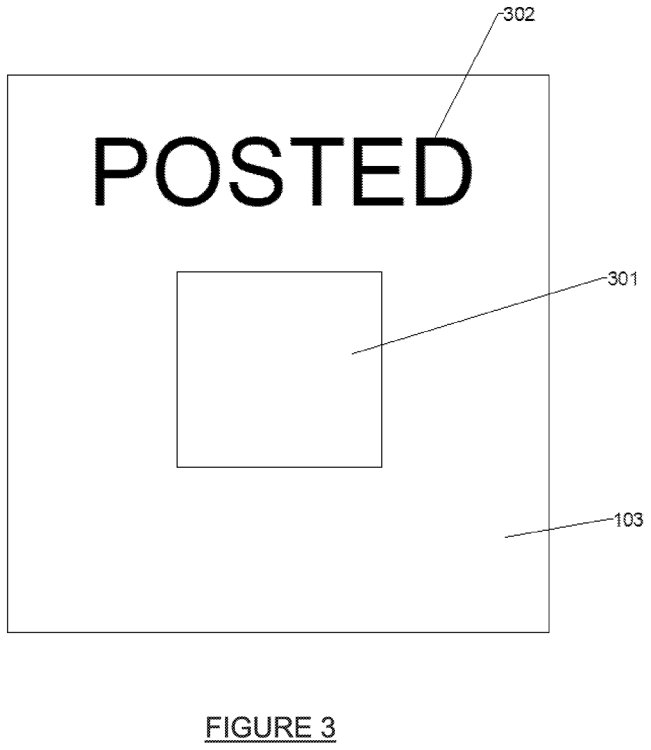

In FIG. 3 an exemplary QR sign 103 is shown. On the sign is a QR code 301. A QR code 301 is understood to be what is called a quick response code or a matrix barcode. Alternatively, this system may also use other types of barcodes or identifiers. The use of a QR code 301 is the preferred type of bar code. On the QR sign 103 a posted message 302 is prominently displayed. The posted message 302 is printed onto the QR sign 103 such that it is in compliance with state and local posting laws. State jurisdictions regulate the required language needed to post land for no hunting which would be found in the posted message 302. Generally, the word “POSTED” would comprise the posted message 302, but it is understood that some jurisdictions require additional language. The important items to be on the QR sign 103 is the QR code 301 and the jurisdictionally required posted message 302.

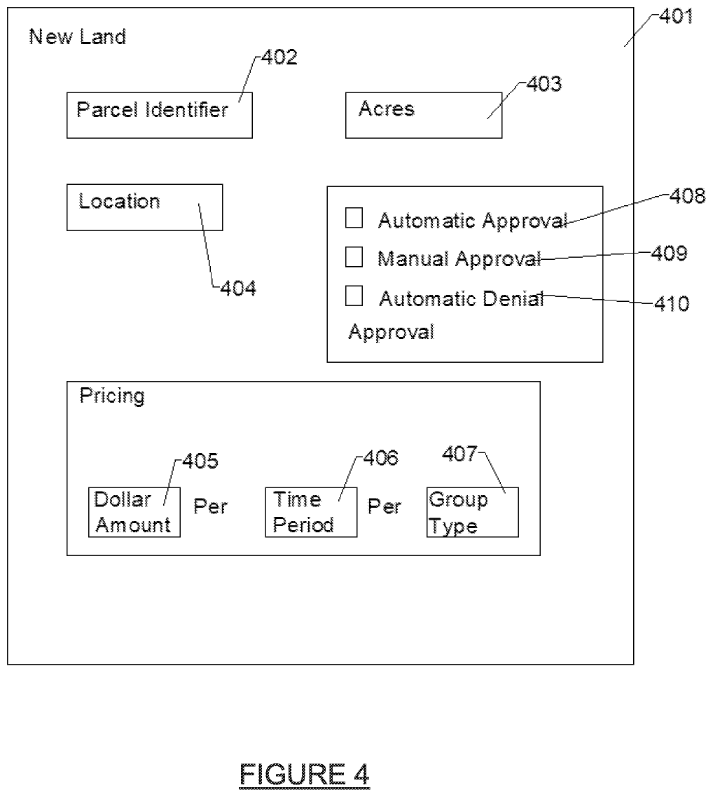

FIG. 4 is an exemplary sign-up page 401 found on a web browser 105 which can be used by a landlord to sign up land parcels. To access the sign-up page 401 a landlord would need to login to the system on a web browser 105. The system is considered the software and hardware needed to carry out the method described herein. The software comprises code which is run on a parcel server 104 and communicated into an interface on mobile browser 106 or a web browser 105 such as Chrome, Internet Explorer, or Firefox. Upon logging into the system, a landlord can have the option to sign up land parcels. The landlord may select a link to access the sign-up page 401.

Once the sign-up page 401 has been accessed, the landlord may input relevant information and communication requirements for the land parcel. Information to be uploaded include but is not limited to a parcel identifier 402, acres 403, location 404, pricing, approval requirements, custom notes, and any other relevant information. A parcel identifier 402 is simply a name which the landlord calls the particular parcel. Acres 403 is the number of acres found within the parcel. Other forms of area measurement may be substituted. The location 404 includes the state in which the parcel is located and a description as to where it is found. Examples of a description as to location may include metes and bounds, intersections, points of interest, geographic features, addresses, and other such descriptors.

Pricing is customized based on the landlord's desire. Pricing can be based on the number of hunters in a hunting party, time periods, and other hunter features such as whether they have dogs, plan to drive on the land, or multiple day discounts. An example of a pricing is $100 per hunter per day. Another example of pricing is $100 per hunting party per 8 hours. The time period 406 is selected by the landlord. The dollar amount 405 is selected by the landlord. The group type 407 is selected by the landlord. Group type 407 may include but is not limited to hunting party or hunter.

Approval options which may be available to the landlord include automatic approval 408 upon agreeing to the terms of service and any required payment, manual approval 409, or automatic denial 410. A manual approval 409 would include the process of the landlord completing the approve 207 step after receiving a request message 206. The automatic denial 410 option would cause a hunter who scans the QR code 301 on the QR sign 103 with a portable device 101 to receive an information page 202 which displays a message informing the hunter that no access onto the parcel is allowed.

### Explanation of Exemplary Language

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A system for automated permission to enter onto land comprising:
a registered parcel, the registered parcel is signed up and on a server, the server is connected to an internet network, the registered parcel having a landlord;
a QR sign, the QR sign having a QR code, the QR sign located near a parcel of land; and
a portable device, the portable device having software to scan a QR code, the portable device used by a user, the portable device having a mobile browser, the portable device is connected to the internet network, when scanned the QR code causing the mobile browser to display information about the registered parcel, a request message sent to the landlord, the request message asking to enter the registered parcel, the landlord accepts or rejects the request message, the mobile browser displaying a denial message or preliminary approval.

2. The system for automated permission to enter onto land of claim 1, wherein the user is a hunter.

3. The system for automated permission to enter onto land of claim 2, further comprising the user to provide personal information for the request message.

4. The system for automated permission to enter onto land of claim 3, wherein the user to login to provide personal information for the request message.

5. The system for automated permission to enter onto land of claim 3, wherein the user enters in information into data collection boxes to provide personal information for the request message.

6. The system for automated permission to enter onto land of claim 3, further comprising a terms of service displayed in the mobile browser when the QR code is scanned.

7. The system for automated permission to enter onto land of claim 6, further comprising the user to submit payment prior to receiving final approval to enter the registered parcel.

8. The system for automated permission to enter onto land of claim 1, wherein the QR sign is further comprised of a word posted on the QR sign.

9. The system for automated permission to enter onto land of claim 1, wherein an approval or a rejection to a request message is automatically displayed to the user.

10. The system for automated permission to enter onto land of claim 1, wherein an approval or a rejection to a request message is manually completed by the landlord.

11. The system for automated permission to enter onto land of claim 1, wherein the landlord is a farmer.

12. The system for automated permission to enter onto land of claim 1, further comprising a web browser used by the landlord to sign up the registered parcel.

13. A system for automated permission to enter onto land comprising:
a registered parcel, the registered parcel is signed up and on a server, the server is connected to an internet network, the registered parcel having a landlord;
a QR sign, the QR sign having a QR code, the QR sign located near a parcel of land, the QR sign is further comprised of a word posted on the QR sign;
a portable device, the portable device having software to scan a QR code, the portable device used by a user, the user is a hunter, the portable device having a mobile browser, the portable device is connected to the internet network, when scanned the QR code causing the mobile browser to display information about the registered parcel, a terms of service displayed in the mobile browser when the QR code is scanned, a request message sent to the landlord, the user to provide personal information for the request message, the request message asking to enter the registered parcel, the landlord accepts or rejects the request message, the mobile browser displaying a denial message or preliminary approval; and
a web browser used by the landlord to sign up the registered parcel.

14. The system for automated permission to enter onto land of claim 13, wherein the landlord is a farmer.

15. The system for automated permission to enter onto land of claim 13, wherein the user is a hunter.
